(19) United States
(12) Patent Application Publication
(10) Pub. No.: US 2006/0045102 A1
(43) Pub. Date: Mar. 2, 2006

(54) Method for recovering a mismatch between a media gateway and a media gateway controller

(76) Inventors: Mariana Benitez Pelaez, Naperville, IL (US); Keiko Katagiri, Naperville, IL (US); Maridi Raju Makaraju, Wheaton, IL (US); Kamlesh C. Patel, Elk Grove Village, IL (US); Robert Wrona, Wheaton, IL (US)

Correspondence Address: Lucent Technologies Inc.;Docket Administrator - Room 3J-219, 101 Crawfords Corner Road, Holmdel, NJ, 07733-3030, US

(21) Appl. No.: 10/931,144

(22) Filed: Aug. 31, 2004

(51) Int. Cl. H04L 12/56; H04L 12/28

(52) U.S. Cl. 370/401

(57) ABSTRACT

The present invention provides a method for recovering a mismatch between a media gateway (MGW) and a media gateway controller (MGC). The MGC believes that a channel is idle and attempts to assign the channel in a bearer connection. The state information of the MGW indicates that the channel is busy. In response to a message indicating that the channel assignment failed from the MGW, the MGC sends a subtract message to the MGW to locate the termination and release that resource by returning the termination to an idle state. At this point the state of the channel has been resynchronized between the MGW and the MGC. The MGW then removes all endpoints associated with the context to release the resource from all contexts and bearer connections.

### FIELD OF THE INVENTION

The present invention relates generally to communication systems, and more particularly to a recovery method upon detection of a state mismatch between a media gateway and a media gateway controller in a multimedia communication system.

### BACKGROUND OF THE INVENTION

A physically decomposed multimedia architecture is one in which a Media Gateway Controller (MGC) controls a Media Gateway (MGW) using a protocol such as ITU H.248. In a decomposed architecture, physical media access points such as TDM (Time Division Multiplexing) channels have a separate logical representation in both the MGW and MGC. This logical representation includes dynamic state information such as whether the channel is in-service or out-of-service and whether the channel is busy or idle.

It is possible that this dynamic state information can get out of synchronization between the MGW and the MGC, either due to a message being lost or due to corruption of the state information. This mismatch may lead to failed calls. The typical recovery behavior in this case is to run an audit between the MGW and the MGC to reconstruct the state information. Unfortunately, the load on the system may make running an audit undesirable, but until the state mismatch is corrected, calls will continue to fail. This resource is thereby lost until the next audit or initialization of the system.

### BRIEF SUMMARY OF THE INVENTION

The present invention describes an improved method to correct the state mismatch when an MGC thinks a channel is idle and an MGW has the channel busy. The present invention brings the channel states of the MGW and MGC back into synchronization after a busy-idle state mismatch has been detected. The present invention provides the method of determining the location, referred to as the context in ITU-T H.248, or other information, such as the packets lost, of a particular termination. The present invention simplifies the recovery procedure of a state mismatch.

The present invention corrects the state mismatch in a reactive fashion rather than a proactive fashion, thereby resolving the state mismatch and returning the channel to service in a faster manner.

### BRIEF DESCRIPTION OF THE SEVERAL VIEWS OF THE DRAWINGS

FIG. 1 depicts a communication system in accordance with an exemplary embodiment of the present invention.

FIG. 2 depicts a call flow diagram of a method for recovering a mismatch between a media gateway and a media gateway controller in accordance with an exemplary embodiment of the present invention.

### DETAILED DESCRIPTION OF THE INVENTION

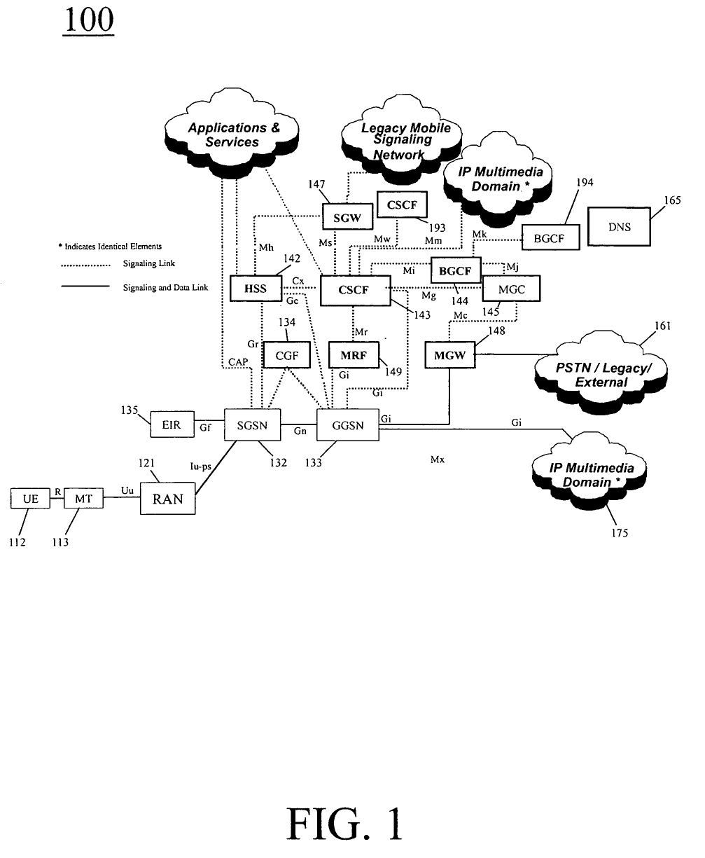

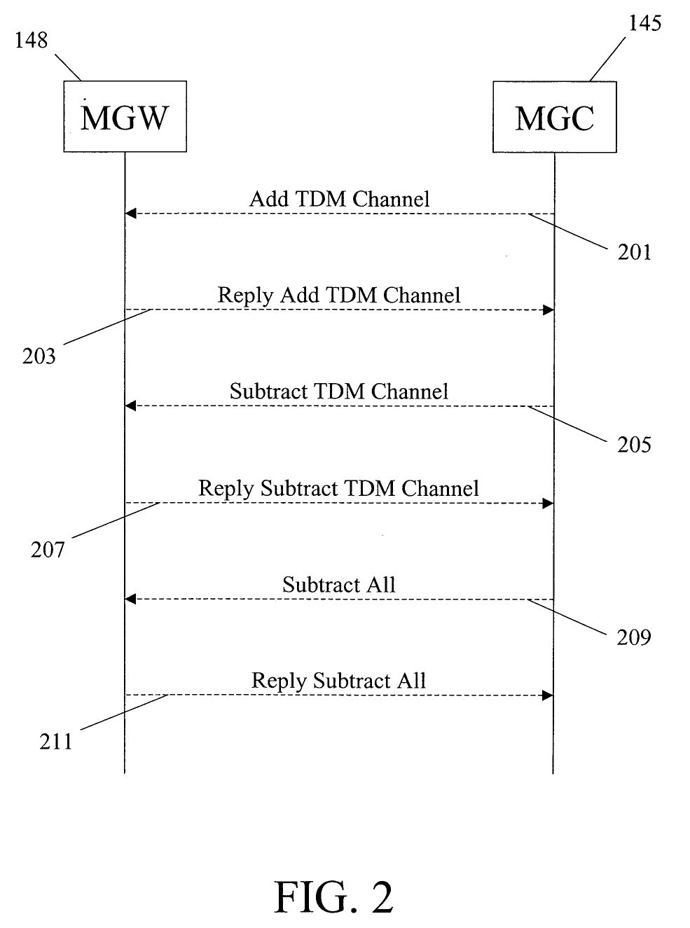

The present invention can be better understood with reference to FIGS. 1 and 2. FIG. 1 depicts a communication system 100 in accordance with an exemplary embodiment of the present invention. In the exemplary embodiment depicted in FIG. 1, communication system 100 is a Third Generation (3G) wireless system. Communication system 100 can alternately be any digital cellular system that includes a distributed architecture that includes a media gateway controller and a media gateway. 3G wireless systems include multiple air interface standards, including cdma2000, Universal Mobile Telecommunications System (UMTS), Wideband CDMA (W-CDMA), Global System for Mobile Communications (GSM), and UWC-136, a TDMA-based technology.

As depicted in FIG. 1, communication system 100 depicts a 3GPP reference architecture of a UMTS wireless network. It should be understood that communication system 100 can alternately be other reference architectures. Communication system 100 includes logical elements that have been defined based on network functions that have been grouped together to form each logical element. Actual implementation may contain multiple copies of these logical elements within multiple networks, and can merge any of these logical elements into single hardware entities. The architecture of the exemplary embodiment of the present invention is designed to utilize emerging Internet standards and protocols. An example of this is the use of Session Initiation Protocol (SIP) for IP Multimedia Subsystem (IMS) signaling for establishing a call. Use of emerging internet-based protocols, such as IPv6, allows for the IMS to provide internet-like functionality and services to mobile units along with voice and data services.

Communication system 100 includes a plurality of logical elements, comprising User Equipment (UE) 112, a Mobile Termination (MT) 113, Radio Access Network (RAN) 121, packet-switched domain 131, IP Multimedia Subsystem (IMS) 141, Charging Gateway Function (CGF) 134, EIR 135, and signaling gateway (SGW) 147.

Both the UMTS-based and GSM/EDGE-based Radio Access Networks are shown in this figure. Charging Gateway Functionality (CGF) 134 is now part of the base 3GPP communication system 100 to show the collection of billing information in packet-switched domain 131. As depicted in FIG. 1, Radio Access Network (RAN) and packet-switched domain 131 are independent of IMS 141.

User equipment can be any device or combination of devices that can be used to connect with a wireless network. User Equipment, for example, can be comprised of User Equipment (UE) 112 and a Mobile Termination (MT) 113. User equipment is preferably a 3G mobile station that communicates with communication system 100 via an air interface supported by communication system 100.

RAN 121 is preferably a UMTS Terrestrial Radio Access Network (UTRAN), which is the primary interface between the wireless device and the UMTS access network. Alternately, RAN 121 can be a GSM/EDGE Radio Access Network (GERAN), which is the primary interface between the wireless device and the GSM/EDGE access network. RAN 121 is coupled to the user equipment via an air interface, such as a 3G air interface.

Packet-switched domain 131 includes Serving GPRS Support Node (SGSN) 132 and GPRS Gateway Support Node (GGSN) 133. SGSN 132 provides packet mobility management, authentication, session management, accounting, mapping of IP addresses to user equipment identification, such as IMSI, maintenance of mobile state information, and interfacing with GGSN 133. GGSN 133 provides interworking between the SGSNs and external packet data networks using IP.

IMS 141 preferably includes Call State Control Function (CSCF) 143, Breakout Gateway Control Function (BGCF) 144, Media Gateway Controller (MGC) 145, Media Gateway (MGW) 148, and Multimedia Resource Function (MRF) 149.

CSCF 143 is a signaling entity for bearer/session control. CSCF 143 manages SIP sessions, provides features/services and coordinates with other network elements for session control, feature/service control and resource allocation.

CSCF 143 performs multiple functions, which in an exemplary embodiment include incoming call gateway, call control function, serving profile database, and address handling. In addition, in accordance with an exemplary embodiment of the present invention, CSCF 143 performs the network call control function for wireless extension functionality.

CSCF 143 has interfaces with many network elements, preferably as defined by the Third Generation Partnership Project standards, in standards document 3GPP TS 23.002. CSCF 143 is preferably connected to a plurality of elements using the SIP protocol. These network elements include GGSN 133 via interface Gi, MT 113 using interface Gm (not shown), MGC 145 using interface Mg, BGCF 144 using interface Mi, MRF 149 using interface Mr, IP Multimedia Domain 175 (not shown), and other CSCFs, such as CSCF 193, using interfaces Mw. CSCF 143 is coupled with HSS 142 via interface Cx, preferably using the DIAMETER protocol. In addition, in accordance with an exemplary embodiment of the present invention, HSS 142 performs the User Profile Data Base function for wireless extension functionality. CSCF 143 is coupled to SGW 147 via interface Ms, which preferably uses a MAP protocol, but can alternately use a CAP or other SS7 application protocol.

BGCF 144 is a signaling entity for bearer/session control. The primary responsibility of BGCF 144 is to select the network to use for inter-working with PSTN 161 for a call from MT 113 to a PSTN address. BGCF 144 preferably performs additional functions, which include but are not limited to selection of the appropriate MGC, hiding of network information from other networks, and provision of security through authorization of peer network elements.

BGCF 144 communicates with CSCF 143 via Mi interface, with MGC 145 via Mj interface, and with BGCF 194 via Mk interface. These interfaces are defined in 3GPP TS 23.002. SIP is the preferred protocol for these standard interfaces. BGCF 144 may also have interfaces with other entities (not shown) to assist in making decisions within communication system 100.

BGCF 144 is preferably a logical entity from the 3GPP reference model. The actual implementation of BGCF 144 may be combined on the same platform with other logical entities that perform signaling functions such as CSCF 143, MGC 145, and SGW 147.

To select a PSTN gateway, BGCF 144 in the home network receives the call origination message, which is an exemplary embodiment is a SIP INVITE message, from CSCF 143. The receipt of a call origination message from CSCF 143 indicates that the destination is a PSTN address. BGCF 144 needs to determine which network should be used to provide inter-working with PSTN 161. BGCF 144 may use data from multiple sources to make this determination. Examples of factors which BGCF 144 may look at in making this determination include, but are not limited to, the current location of the calling UE, the location of the PSTN address, local policies and business agreements between the visited and home networks, the desire to minimize path distance within the PSTN network, and a desire for the least-cost path. If the PSTN gateway is decided to be the home network, an MGC within the home network, such as MGC 145, will be selected. If the PSTN gateway is decided to be at another network, the BGCF address for the other network must be determined so that the processing may be forwarded to that network.

BGCF 144 may also provide information hiding functionality. When two BGCFs are used across a network boundary, then the BGCFs may be used to hide local network information from the other network. BGCF 144 can also provide security in communication system 100. BGCF 144 provides security by performing authorization of peer network elements for peer-to-peer SIP application level communication.

MGC 145 terminates signaling and provides the call control interface and translations between IMS 141 and PSTN 161. MGC 145 also provides connection control for the media channels in MGW 148. MGC 145 communicates with MGW 148 via the Mc interface, with BGCF 144 via the Mj interface, and with CSCF 143 via the Mg interface.

MGC 145 also preferably provides signaling to control a set of Media Gateways (MGW), such as MGW 148. This signaling is preferably in the form of H.248. With H.248, MGC 145 is able to control establishment of bearer resources for sessions that require inter-working for bearer between PSTN 161 and IMS 141. For calls that require the services of a network operator's MGW, ports are allocated via requests from MGC 145 within that network operator's network.

Signaling allows MGC 145 to perform multiple operations with respect to MGW 148. These operations include MGW registration, bearer establishment control between IMS 141 and PSTN 161, request for allocation of media translation resources (i.e., compression, echo cancellation, vocoding, etc.), control of events detected at MGW 148, application of signals such as tones and announcements by MGW 148, and collection of statistics.

MGC 145 preferably controls multiple MGWS. To be placed into service, the MGWs register themselves with their default MGC. After registration with an MGC, MGWs can begin bearer processing.

MGC 145 preferably implements a SIP-based interface to CSCF 143. BGCF 144 may be in the signaling path between CSCF 143 and MGC 145. Using this interface, MGC 145 accepts commands from CSCF 143 to perform functions related to the control of a call.

MGW 148 is the element that translates between a media flow, such as voice, on a given IP network and bearer data on PSTN 161. MGW 148 terminates circuit-switched bearer traffic from PSTN 161 and terminates IP media flow as packet streams through GGSN 133 or MGW 173, eventually reaching the user equipment. MGW 148 preferably performs vocoding and may also provide tones and announcements. If in-band signaling methods are supported at MGW 148, then for PSTN traffic using in-band signaling, MGW 148 preferably terminates both bearer and signaling traffic, and forwards the signaling messages to MGC 145. MGW 148 interfaces with GGSN 133 via the Gi interface and with MGC 145 via the Mc interface.

MGW 148 may include resources to modify a bearer stream. These resources allow MGW 148 to perform encoding, compression, echo cancellation, packetization, transcoding, packet timing synchronization, and packet loss handling.

MGW 148 preferably supports multiple types of voice encoding. These include, but are not limited to, G.711, Adaptive Multi-Rate (AMR), and other G.7xx encoding schemes. MGW 148 is preferably able to use G.711 to encode and decode voice on trunks connected to a PSTN network.

MGW 148 preferably organizes bearer connections using H.248 contexts containing terminations. MGW 148 may include numerous simultaneous contexts.

MGW 148 also preferably includes resources to support a plurality of signaling mechanisms, including but not limited to registration with MGC 145, detection of events (e.g. Dual-Tone Multi-Frequency (DTMF) detection), application of tones and announcements to bearer streams, graceful teardown and random restart, notification, generation of statistics, and support of H.248 packages.

MRF 149 provides packet-based media services, such as advanced announcement generation and detection, N-way conferencing, tone and announcement generation, and future advanced media services, such as video mixing. In addition, in accordance with an exemplary embodiment of the present invention, MRF 149 performs the network conference bridge function for wireless extension functionality. MRF 149 also preferably provides transcoding and interactive voice response. MRF 149 interfaces with CSCF 143 via the Mr interface, with IP Multimedia Domain 175 (not shown), and with GGSN 133 via the Gi interface.

In an exemplary embodiment of the present invention, MRF 149 comprises two parts, a controller part and a bearer part. CSCF 143 preferably interfaces with the MRF controller part to request media services using SIP. The controller part preferably communicates with the bearer part via H.248. The bearer part preferably supports RTP/UDP/IP. Some of the resources maintained by MRF 149 include vocoders, transcoders, compression entities, bearer-stream mixers, echo cancellors, and other DSP resources. Vocoders are needed at MRF 149 for transcoding and mixing of multimedia streams.

HSS 142 provides support for subscriber authentication, subscriber profile management, service authorization, subscriber location management, inter-system handover, and call routing. HSS 142 provides these functions for users receiving service from circuit-switched domain 151, packet-switched domain 131, and IMS 141.

HSS 142 preferably maintains a subscriber database that includes information including, but not limited to, the identity of the subscriber, services and associated policies, location, and authentication data.

HSS 142 supports the following interfaces. Interface Cx is the interface to CSCF 143. The preferred protocol for this interface is DIAMETER. Interface Mh is the interface to SGW 147. Interface Gr is the interface to SGSN 132. Interface Gc is the interface to GGSN 133. Interface C is the interface to GMSC server 153. Interfaces Mh, Gr, Gc, D and C preferably utilize a MAP protocol.

In accordance with an exemplary embodiment of the present invention, HSS 142 recognizes when features and services are to be implemented for a subscriber at either MSC server 152 or IMS 141. In addition, HSS 142 supports procedures for IMS-homed mobile units being served at a remote MSC Server.

SGW 147 terminates transport protocols for signaling between PS domain 113 and IMS 141. The services of SGW 147 are preferably used to ensure transport interworking between the SS7 and the IP transport of signaling on its various interfaces (not all shown). SGW 147 communicates with CSCF 143 and HSS 142 via the Ms and Mh interfaces, respectively.

SGW 147 provides for HSS Subscriber roaming into circuit-switched wireless networks and transport of circuit-switched signaling over IP, such as TCP/IP.

FIG. 2 depicts a call flow diagram 200 of a method for recovering a mismatch between media gateway 148 and media gateway controller 145 in accordance with an exemplary embodiment of the present invention.

In the exemplary embodiment depicted in FIG. 2, MGC 145 believes that a channel, designated in H.248 as PHY_TermID, is idle and attempts to use this termination, which is a TDM channel, in a bearer connection. MGC 145 sends Add TDM termination message 201 to MGW 148 to add the channel that MGC 145 thinks is available to a context. As used herein, a context is a logical construct that represents a bearer connection through MGW 148.

The state information of MGW 148 indicates that the termination that MGC 145 is attempting to add to a context is busy. MGW 148 sends Reply Add TDM Message 203 to MGC 145. Reply Add TDM Message 203 in this exemplary embodiment includes an indication that the request to add the termination to a context has failed. In an exemplary embodiment of the present invention, MGW 148 returns a failure return code of “433”, which indicates that the channel already exists in another context, i.e. context, and thus is already a part of another bearer connection. At this point MGC 145 knows that there is a state mismatch between itself and MGW 148 with respect to the termination.

In accordance with the present invention, MGC 145 will re-synchronize the state mismatch in near real-time, thereby allowing the channel to be used quicker than in the prior art. According to the prior art, the state mismatch would remain until either an audit was run for the system or until the communication system was reinitialized.

In accordance with the exemplary embodiment of the present invention, to correct this state mismatch, MGC 145 sends a Subtract Command message 205 to MGW 148. MGC 145 does not know which call, or context, the termination is associated with. MGC 145 issues Subtract Command message 205 to MGW 148 making use of a wildcard character, such as “*”, for the context identifier. The wildcard character indicates to MGW 148 to search for the particular termination in question in all contexts.

MGW 148 locates the termination and releases that resource by returning the termination to the NULL context. The NULL context is the context assigned to idle physical terminations. When the channel is successfully subtracted, MGW 148 sends Subtract Reply Command message 207 to MGC 145. The Subtract Reply Command message 207 indicates the specific context in which this channel was located. MGC 145 may request additional information when issuing the subtract command. MGC 145 can include a request for one or more statistics about the termination, such as duration of the call, packets sent, packets received, packets lost, octets sent, octets received, jitter, or delay. At this point the state of the channel has been resynchronized between MGW 148 and MGC 145, and now is considered idle in both MGC 145 and MGW 148. However, MGC 145 must still completely remove other terminations from the context in which the termination was found.

Once MGC 145 is aware of the context that contained the mismatched termination, MGC 145 can remove the context and thus any associated residual bearer connection. MGC 145 sends a Subtract All message 209 to MGW 148 to remove all endpoints associated with the context that previously contained the mismatched termination. The wildcard option “*” is used again to indicate that anything remaining in the context must be released. The wildcard is necessary because MGC 145 is most likely unaware of this context and anything inside it.

MGW 148 sends Reply Subtract All message 211 to MGC 145 upon the completion of the subtract operation. Reply Select All message 211 includes the list of terminations that were removed. The context and thus the bearer connection are now released. The recovery of the state mismatch between MGC 145 and MGW 148 is now complete.

The present invention thereby provides a faster and more efficient method for correcting a state mismatch between two elements of a communication system. By correcting the state mismatch in near real-time fashion, the channel will be brought back into service upon detection of the mismatch. This is a great improvement over the prior art, which would not resolve the state mismatch until either an audit was run or the system was reinitialized. Either of these procedures disrupts system usage and utilizes a great amount of system resources.

While this invention has been described in terms of certain examples thereof, it is not intended that it be limited to the above description, but rather only to the extent set forth in the claims that follow.

We claim:

1. A method for recovering a mismatch between a media gateway and a media gateway controller comprising:
sending an add message from a media gateway controller (MGC) for a bearer connection on a channel that the MGC believes is idle;
receiving a reply message at the MGC, the reply message including an indication that the add message has failed; and
sending a subtract message from the MGC to subtract the channel from all calls.

2. A method for recovering a mismatch between a media gateway and a media gateway controller in accordance with claim 1, wherein the step of receiving a reply message at the MGC comprises receiving a reply message including an indication that the channel is considered busy by the media gateway.

3. A method for recovering a mismatch between a media gateway and a media gateway controller in accordance with claim 1, wherein the step of sending a subtract message comprises requesting additional information regarding the channel.

4. A method for recovering a mismatch between a media gateway and a media gateway controller in accordance with claim 3, wherein the additional information comprises the duration of the call on the channel.

5. A method for recovering a mismatch between a media gateway and a media gateway controller in accordance with claim 3, wherein the additional information comprises the number of packets sent on the channel.

6. A method for recovering a mismatch between a media gateway and a media gateway controller in accordance with claim 3, wherein the additional information comprises the number of packets received on the channel.

7. A method for recovering a mismatch between a media gateway and a media gateway controller in accordance with claim 3, wherein the additional information comprises the number of packets lost on the channel.

8. A method for recovering a mismatch between a media gateway and a media gateway controller in accordance with claim 3, wherein the additional information comprises the number of octets sent on the channel.

9. A method for recovering a mismatch between a media gateway and a media gateway controller in accordance with claim 3, wherein the additional information comprises the number of octets received on the channel.

10. A method for recovering a mismatch between a media gateway and a media gateway controller in accordance with claim 3, wherein the additional information comprises the jitter on the channel.

11. A method for recovering a mismatch between a media gateway and a media gateway controller in accordance with claim 3, wherein the additional information comprises the delay on the channel.

12. A method for recovering a mismatch between a media gateway and a media gateway controller in accordance with claim 1, the method further comprising the step of removing all terminations from the channel.

13. A method for recovering a mismatch between a media gateway and a media gateway controller comprising:
receiving an add message from a media gateway controller (MGC) at a media gateway (MGW) for a bearer connection on a channel, the add message indicating that the MGC thinks that the channel is idle;
sending a reply message from the MGW, the reply message including an indication that the add message has failed; and
receiving a subtract message at the MGW, the subtract message requesting the MGW to subtract the channel from all calls.

14. A method for recovering a mismatch between a media gateway and a media gateway controller in accordance with claim 13, the method further comprising the step of releasing the channel at the MGW in response to the subtract message.

15. A method for recovering a mismatch between a media gateway and a media gateway controller in accordance with claim 14, wherein the step of releasing the channel comprises setting the channel to a NULL context at the MGW.

16. A method for recovering a mismatch between a media gateway and a media gateway controller in accordance with claim 14, the method further comprising the step of sending a subtract reply message from the MGW.

17. A method for recovering a mismatch between a media gateway and a media gateway controller in accordance with claim 16, wherein the subtract reply message includes the specific context in which the channel was located.

18. A method for recovering a channel state mismatch between a media gateway and a media gateway controller comprising:
attempting to use a channel in a bearer connection that the MGC thinks is idle;
determining at the MGW that the channel is busy;
sending an add error message from the MGW indicating that the channel is busy;
issuing a subtract command from the MGC to resynchronize the channel between the MGC and the MGW;
locating at the MGW the context identifier for the channel; and
removing the residual bearer connection from the channel by the MGC.
